(19) United States
(12) Patent Application Publication
(10) Pub. No.: US 2025/0050713 A1
(43) Pub. Date: Feb. 13, 2025

(54) Aftermarket dimmable sunroof

(71) Applicant: Wicue USA INC., Santa Clara, CA (US)

(72) Inventors: Cai GUO, Santa Clara, CA (US); Fenghua LI, Santa Clara, CA (US); Wei YANG, Santa Clara, CA (US); Dezhen YU, Santa Clara, CA (US)

(73) Assignee: Wicue USA INC., Santa Clara, CA (US)

(21) Appl. No.: 18/902,663

(22) Filed: Sep. 30, 2024

Related U.S. Application Data
(60) Provisional application No. 63/518,776, filed on Aug. 10, 2023.

(51) Int. Cl. B60J 3/04; B60J 3/00; G02F 1/133; G02F 1/1333

(52) U.S. Cl. CPC B60J 3/04; B60J 3/007; G02F 1/13324; G02F 1/133382; G02F 2202/04; G02F 2202/28

(57) ABSTRACT

The present invention discloses an aftermarket dimmable sunroof for mounting to an automobile sunroof, characterized in that it includes a heat-insulating solar film, a first adhesive layer, a liquid crystal dimming layer, a second adhesive layer, and a substrate that are laminated in a sandwich type arrangement. The liquid crystal dimming layer contains at least one layer of liquid crystal dimming film, and the liquid crystal dimming film is used to adjust the transmittance of the aftermarket dimmable sunroof.

### CROSS-REFERENCE TO RELATED APPLICATION

This application claims priority to and the benefit of U.S. Provisional Patent Application No. 63/518,776, filed on Aug. 10, 2023, the disclosure of which is incorporated herein by reference in its entirety.

### TECHNICAL FIELD

The present invention relates to the technical field of automobile canopies, and particularly relates to an aftermarket dimmable sunroof.

### BACKGROUND

Currently in the field of automotive technology, panoramic sunroofs have become increasingly popular as automotive technology continues to advance. However, many sunroofs in the prior art take the form of a sunshade, which significantly affects the view. Moreover, some electric vehicles feature panoramic sunroof glass with fixed light transmittance and no sunshade. As a result, the sunroof glass heats up when exposed to sunlight, leading to elevated temperatures inside the vehicle and discomfort for passengers. These limitations fail to fulfill the passengers' requirements for viewing, sunshade, and heat insulation. To address these issues, a new type of panoramic sunroof is necessary. Currently, electrochromic panoramic sunroofs in vehicles are typically manufactured by sandwiching electrochromic material between two glass substrates. However, due to the large curvature of automobile sunroof glass, the production cost is high, and the preparation process is challenging. Sandwiching electrochromic materials under excessive pressure can easily damage the material, resulting in a low yield rate. Additionally, undesirable outcomes like wrinkles and bubbles may appear after sandwiching. Consequently, the existing technology faces difficulties in large-scale production of sunroof glass.

### SUMMARY

The main objective of the present invention is to propose an aftermarket dimmable sunroof for mounting to an automobile sunroof, characterized in that it includes a heat-insulating solar film, a first adhesive layer, a liquid crystal dimming layer, a second adhesive layer, and a substrate that are laminated in a sandwich type arrangement.

Said aftermarket dimmable sunroof is fixedly installed on the inner side of the original sunroof glass of the vehicle by means of an adhesive or a mechanical fixation structure; the mechanical fixation structure includes common fixation devices such as a buckle device, a magnetic attraction device, a screw fixation device, etc.

Said liquid crystal dimming layer comprises at least one layer of liquid crystal dimming film used for regulating the transmittance of the aftermarket dimmable sunroof;

Said liquid crystal material within the liquid crystal dimming film comprises liquid crystal molecules, chiral dopants, and dye molecules;

Said substrate is made of transparent material, and said substrate is used for maintaining the mechanical integrity of the aftermarket dimmable sunroof and provide attachment points to be attached to inner side of the original sunroof.

When electricity is supplied to the liquid crystal dimming layer, it is transparent with a transmittance range of 5%-70%; when the power supply to the liquid crystal dimming layer is cut off, it is in a dark state, with a transmittance range of 0.1%-15%.

Further, said heat insulating solar film is a reflective heat insulating solar film capable of reflecting infrared and ultraviolet radiation.

Further, said liquid crystal material within said liquid crystal dimming layer is a PDLC material, capable of switching between transparency and opaqueness. When electricity is supplied to the liquid crystal dimming layer, it is in a transparent state with a transmittance range of 5%-80%; when the power supply to the liquid crystal dimming layer is cut off, it is in a dark state, with a transmittance range of 0.5%-20%.

According to actual needs, the liquid crystal material within the liquid crystal dimming layer can also be chosen as TN (Twisted Nematic) liquid crystal material.

Further, said substrate is made of one of PC, PET, PMMA, PVC, PP, TAC.

Further, said first adhesive layer and said second adhesive layer are made of the one of OCA, PVB, EVA, TPU.

Further, the thickness of said first adhesive layer and said second adhesive layer ranges from 0.05 mm-2 mm.

Further, the thickness of said substrate ranges from 2 mm-5 mm.

Further, said liquid crystal dimmable film comprises a first substrate layer, a first conductive layer, a liquid crystal layer, a second conductive layer, and a second substrate layer stacked in a sequential order;

Said aftermarket dimmable sunroof further comprises a drive module, said drive module being electrically connected to said first conductive layer and said second conductive layer, respectively, for applying a drive voltage to said first conductive layer and said second conductive layer.

Further, said drive module comprises a power supply, a control chip, and a switch, said control chip being electrically connected to said first conductive layer, said second conductive layer, said power supply, and said switch, respectively.

Further, said power source comprises a transparent solar film, said transparent solar film being attached to the side of said heat insulating solar film facing outward relative to the cockpit of the automobile;

Or said power source comprises a rechargeable battery;

Or said power source comprises an automotive battery.

Further, said drive module further comprises a voice control module and a wireless control module.

The beneficial effects of the technical solution of the present invention compared to the prior art are:

1. The disclosed invention pertains to a novel aftermarket dimmable sunroof system incorporating PDLC, GH, or TN liquid crystal films in association with a Liquid Crystal Dimming layer. The design offers the potential for customization of the dimmable sunroof's color palette, as per consumer demand. Furthermore, the system comprises an adjustable transmittance property, allowing tailored light adjustment. A significant enhancement in the sunroof's shading and thermal insulation functionality is achieved via the inclusion of a solar film, particularly a reflective solar film.

2. The invention additionally involves an aftermarket dimmable sunroof designed for unobtrusive incorporation with existing automobile sunroofs. The focus is on direct aftermarket installation to the sunroof glass, enabled by the sunroof's flexible material composition. The material allows for efficient utilization of the space existing between the original sunroof glass and the headliner, thereby obviating the need for sunroof removal during the installation process. The resulting manufacturing and installation methodologies are simple yet efficient, minimizing both manufacturing and installation costs.

### BRIEF DESCRIPTION OF THE DRAWINGS

FIG. 1 shows a schematic diagram of the structure of the aftermarket dimmable sunroof of Embodiment 1 of the present invention;

FIG. 2 is a schematic diagram of the structure of a liquid crystal dimming film of the present invention;

FIG. 3 shows a schematic diagram of the structure of the aftermarket dimmable sunroof of Embodiment 1 of the present invention installed on the roof of a vehicle;

FIG. 4 shows a schematic diagram of a circuit connection between the aftermarket dimmable sunroof of Embodiment 1 of the present invention and a drive module;

FIG. 5 shows a schematic diagram of the structure of the aftermarket dimmable sunroof of Embodiment 2 of the present invention;

FIG. 6 shows a schematic diagram of the structure of the aftermarket dimmable sunroof of Embodiment 3 of the present invention;

FIG. 7 shows a schematic diagram of the structure of the aftermarket dimmable sunroof of Embodiment 4 of the present invention;

FIG. 8 shows a schematic diagram of the structure of the aftermarket dimmable sunroof of Embodiment 4 of the present invention installed on the roof of a vehicle;

FIG. 9 shows a schematic diagram of dimming region partition of the aftermarket dimmable sunroof of Embodiment 5 of the present invention.

### DESCRIPTION OF THE LABEL IN THE FIGURE

100: heat-insulating solar film; 200: a first adhesive layer; 300: a liquid crystal dimming layer; 400: a second adhesive layer; 500: a substrate; 600: an automobile sunroof; 700: a drive module; 701: a power supply; 702: a control chip; 703: a switch; 704: a voice control module; 705: a wireless control module; 800: a dimmable region; 900: a liquid crystal dimming film; 901: a first substrate layer; 902: a first conductive layer; 903: a liquid crystal layer; 904: a second conductive layer; 905: a second substrate layer; 1000: headliner of the vehicle.

### DETAILED DESCRIPTION

The following will provide a clear and comprehensive description of the embodiments in this invention, using the accompanying diagrams in the embodiments of this invention. It should be noted that the described embodiments are merely a subset of the possible embodiments within this invention, and not all the embodiments. All other embodiments that a person with ordinary skill in the field can derive without making creative effort, based on the embodiments in this invention, fall within the scope of protection of this invention.

Motivation of this patent application is as follows.

The motivation behind this patent application is to address the issue of large sunroof panels in vehicles causing discomfort to passengers due to excessive heat during hot summer days. The existing sunroof solutions are cost-saving for automotive OEMs, but they lack effective shading mechanisms, leading to increased CO2 pollution from excessive air conditioning usage and reduced driving range. Additionally, these large glass sunroof solutions are preferred to save vehicle height and provide more head distance, but they lack dimmable features, making it difficult for passengers to watch videos, work with laptops or mobile phones while driving. Replacing the sunroof with a very dark tint is not ideal as it diminishes the advantage of having a glass sunroof and involves significant replacement costs.

The proposed solution presented in this patent application aims to provide a more cost-effective approach than replacing the entire sunroof. It introduces new leading-edge shading features that are expected to become standard in the future.

### Embodiment 1

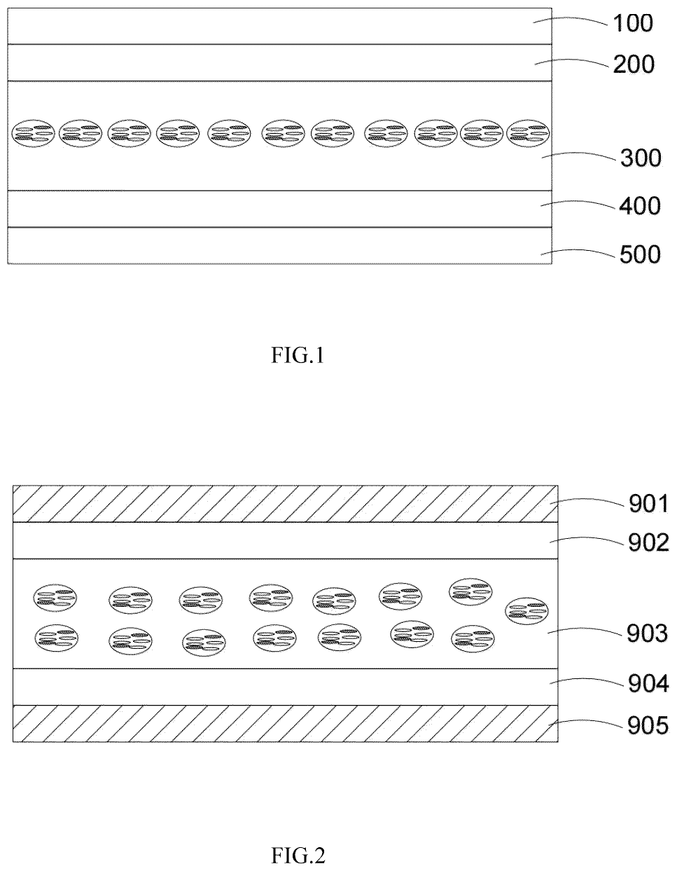

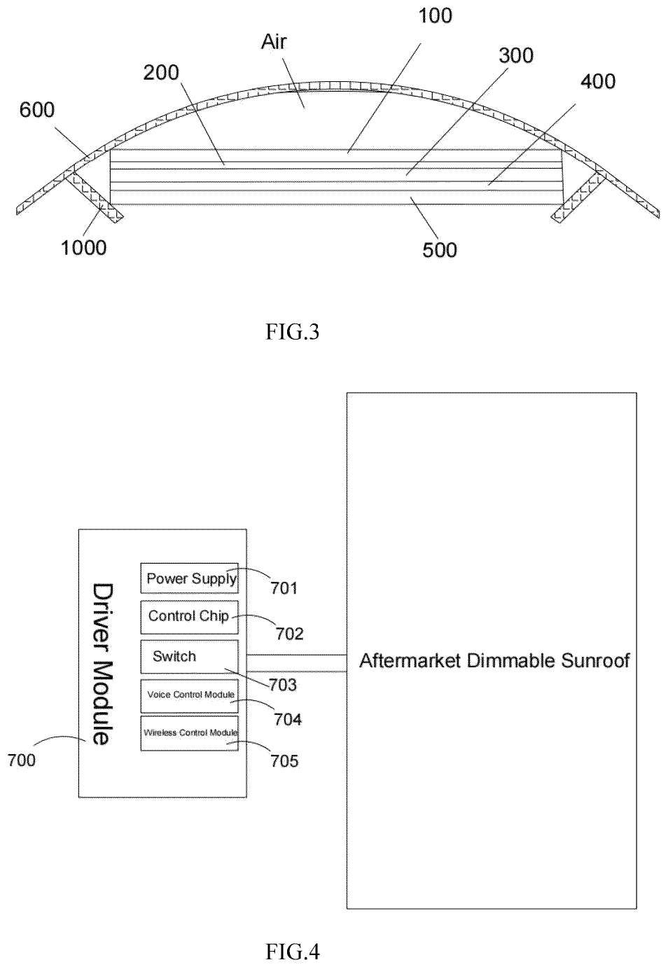

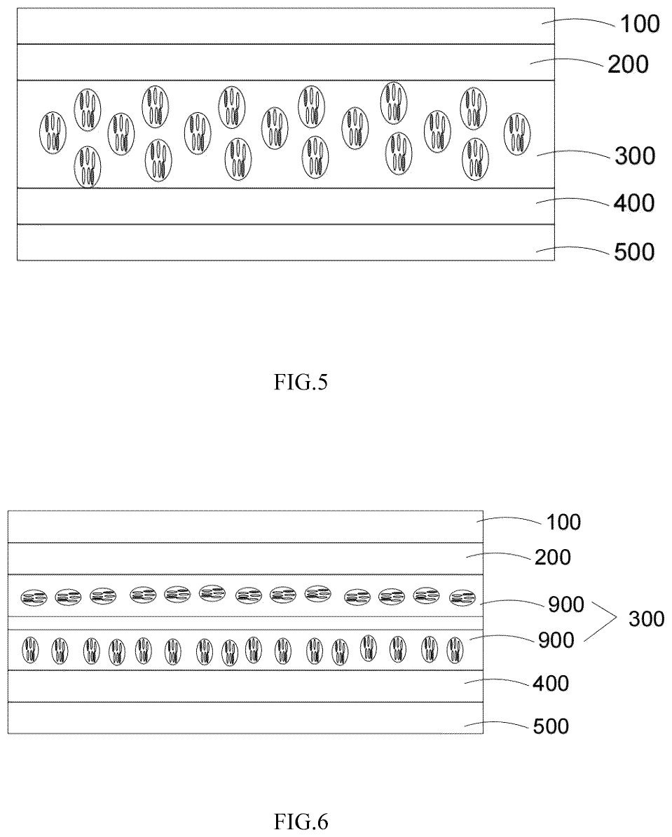

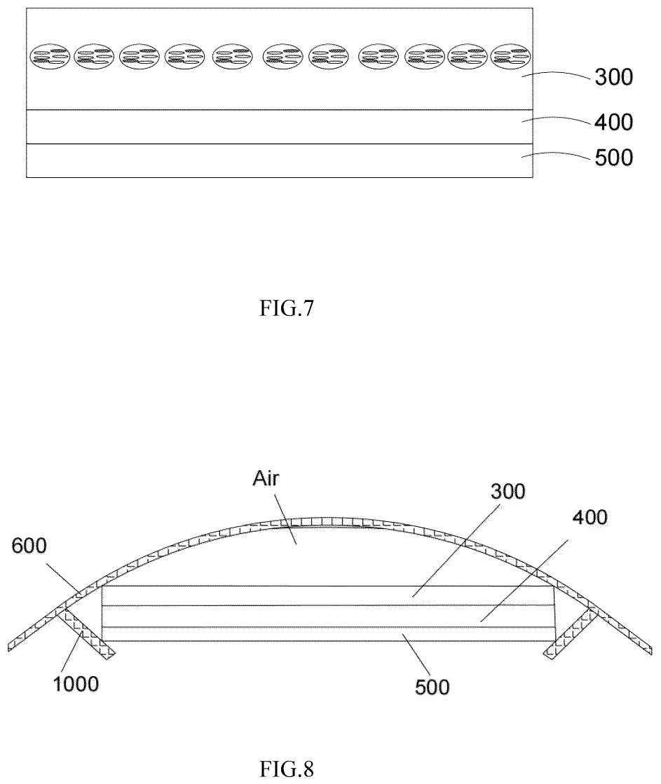

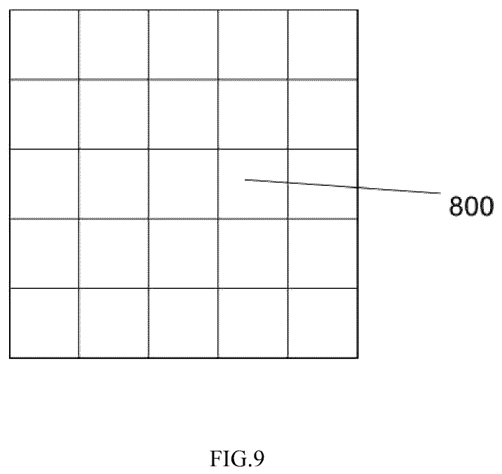

Referring to FIG. 1, this embodiment proposes an aftermarket dimmable sunroof for mounting to an original automobile sunroof 600, including a heat-insulating solar film 100, a first adhesive layer 200, a liquid crystal dimming layer 300, a second adhesive layer 400, and a substrate 500 that are laminated in a sandwich type arrangement; Said liquid crystal dimming layer 300 contains a liquid crystal dimming film, and said liquid crystal dimming film is used to adjust the transmittance of an aftermarket dimmable sunroof; The liquid crystal material within said liquid crystal dimming film is a polymer doped with liquid crystal molecules and dye molecules with positive dielectric anisotropy Δε. Said substrate 500 is made of a transparent material and said substrate 500 is used for maintaining the mechanical integrity of the aftermarket dimmable sunroof and providing attachment points to be mounted to inner side of the original sunroof. Said liquid crystal dimming film 900 comprises a first substrate layer 901, a first conductive layer 902, a liquid crystal layer 903, a second conductive layer 904, and a second substrate layer 905, which are stacked in a sequential order.

The material within said liquid crystal dimming film is a polymer doped with liquid crystal molecules and dye molecules with positive dielectric anisotropy Δε. The liquid crystal layer within the conventional PDLC dimming film is usually doped with pure liquid crystal molecules with positive dielectric anisotropy Δε, and the liquid crystal molecules' long axes are aligned parallel to the direction of the electric field when energized. Polymer molecules have isotropic refractive index nₚ, while liquid crystal molecules have anisotropic refractive indices, nₑ and n₀, which refer to the refractive indices in extra-ordinary and ordinary directions respectively. Here if nₑ is made to be equal to nₚ, then viewed from a direction perpendicular to the surface of the substrate, the view is low haze transparency. However, when viewed at an angle, the refractive index of the liquid crystal molecules is between n₀ and nₑ, which is significantly different from the refractive index np of the polymer, and thus exhibiting a scattering hazy state. In this embodiment, a certain proportion of dye liquid crystal molecules are doped in the polymer, wherein the dielectric anisotropy Δε of the liquid crystal molecules is positive, i.e., the direction of the long axis of the liquid crystal molecules when energized is parallel to the direction of the electric field and perpendicular to the surface of the substrate.

When the power is off, the liquid crystal molecules and dye molecules are chaotically arranged in the polymer, and the refractive indices of their mixtures are different in all directions, which is manifested as a highly scattering hazy state. Due to the presence of the dye molecules, the hazy state shows the color of the dyes, such as hazy grey or hazy black, and so on.

When the liquid crystal molecules are energized, the dye molecules are driven so that the long axis of the molecules are parallel to the direction of the electric field and thus aligned perpendicular to the surface of the substrate. The dye molecules have the characteristics of a polarizer in the perpendicular direction, so that they can selectively allow the light polarized in a certain direction to pass through, and absorb the scattered light polarized in the other directions, which enables the dye PDLC to present a wide-viewing angle and a clear field of view at this time.

When said liquid crystal dimming layer 300 is energized, said aftermarket dimmable sunroof is in a bright state, the transmittance of said aftermarket dimmable sunroof when it is in a bright state ranges from 5% to 80%, and when said liquid crystal dimming layer 300 is de-energized, said aftermarket dimmable sunroof is in a dark state, the transmittance of said aftermarket dimmable sunroof when it is in a dark state ranges from 0.5% to 20%.

In this embodiment, said heat insulating solar film 100 is a reflective heat insulating solar film, capable of reflecting infrared and ultraviolet rays. Reflective solar films are made up of multiple layers of material where the base layer is usually a polyester film, and the coating is a metallic film. The metallic film reflects the sun's rays, thus reducing the temperature inside the vehicle. The advantage of this insulating solar film is that it reduces the temperature inside the vehicle and improves comfort. In addition, it prevents UV and infrared rays from entering the vehicle, protecting passengers and the contents of the vehicle interior.

In this embodiment, the material of said substrate 500 is preferably made of PC, and of course one of PET, PMMA, PVC, PP and TAC can be used according to the actual needs. Advantages of the preferred use of PC material as substrate 500 are that it has high impact strength, a wide range of operating temperatures, a high degree of transparency, low molding shrinkage, good dimensional stability, good fatigue resistance, good weathering resistance. The thickness of said substrate 500 is set to 3 mm.

In this embodiment, the material of said first adhesive layer 200 and said second adhesive layer 400 are the same, both OCA, and of course other materials like PVB, EVA and TPU can be selected according to actual needs. OCA, Optical Clear Adhesive is a special adhesive used for bonding transparent optical components, which belongs to the class of pressure-sensitive adhesives. Optical Clear Adhesive (OCA) functions by sandwiching a layer of transparent adhesive between two non-substrate materials, while applying release films on the outer surfaces. This process produces a high-transparency, double-sided laminating tape that adheres effectively. The advantage of using OCA as the adhesive layer of the liquid crystal film is that it has the advantages of high transparency, high adhesion and high weather resistance. The thickness of said first adhesive layer 200 and said second adhesive layer 400 is set at 0.125 mm.

In this embodiment, said aftermarket dimmable sunroof further comprises a drive module 700, said drive module 700 being electrically connected to said first conductive layer 902 and said second conductive layer 904, respectively, for applying a drive voltage to said first conductive layer 902 and said second conductive layer 904. Said drive module 700 further comprises a voice control module 704 and a wireless control module 705. Said drive module 700 comprises a power supply 701, a control chip 702 and a switch 703, said control chip 702 being electrically connected to said first conductive layer 902, said second conductive layer 904, said power supply 701 and said switch 703, respectively. Said power source 701 comprises a transparent solar film, said transparent solar film being attached to the outward facing side of said insulating solar film 100 with respect to the automobile cockpit; or said power source 701 comprises a rechargeable battery; or said power source 701 comprises an automotive battery.

Referring to FIG. 2, when installing the aftermarket dimmable sunroof onto a vehicle, the edges of the substrate 500 are inserted into the gaps between the original vehicle sunroof glass and the vehicle headliner 1000; or the edges of substrate 500 is attached to the headliner 1000 or the inner side of the original sunroof using adhesive, clasps, or other fixation methods. The exact form of mounting the aftermarket dimmable sunroof depends on the actual type of vehicle and customer requirements. To realize the dimming function, it is necessary to install a drive module 700. The drive module 700 includes components such as a power supply 701, a control chip 702, and a switch 703. Among them, the power supply 701 may be any one of a transparent solar film, a rechargeable battery, or an automobile battery.

Specifically, if one chooses to use a transparent solar film as the power source 701, it needs to be attached to the side of the insulating solar film 100 facing outward relative to the cockpit of the vehicle. In this way, when sunlight strikes the solar film, the solar energy is converted into electrical energy to provide power to the drive module 700. In addition, it is necessary to set up corresponding circuits in the control chip 702 to adjust the power output according to the user's needs.

In the instance that a rechargeable battery is selected as power source 701, said battery is installed on the exterior of the aftermarket dimmable sunroof. Appropriate circuits are configured within the control chip 702 to effectively manage the battery's charging and discharging states, tailored to user specifications. For enhanced safety, additional protective features, including overcharge and overdischarge protections, are integrated into the system.

Alternatively, should a vehicle's battery be adopted as the power source 701, it necessitates connection either directly to the driver module 700, or indirectly via the vehicle system's power supply circuit. To ensure suitable output voltage and current from the battery according to user preferences, corresponding circuits are established within the control chip 702. To safeguard against potential hazards, and assure the overall safety, the system incorporates overcharge and overdischarge protection features.

Finally, the voice control module 704 and the wireless control module 705 are installed. The voice control module 704 can control the dimming function by voice commands; the wireless control module 705 can realize the control of dimming function by remote control methods such as via cell phone APP or a stand-alone remote control.

### Embodiment 2

Referring to FIG. 1, this embodiment proposes an aftermarket dimmable sunroof comprising a heat-insulating solar film 100, a first adhesive layer 200, a liquid crystal dimming layer 300, a second adhesive layer 400, and a substrate 500 that are laminated in a sandwich type arrangement; Said liquid crystal dimming layer 300 contains a liquid crystal dimming film, and said liquid crystal dimming film is used to adjust the transmittance of an aftermarket dimmable sunroof; The liquid crystal material within said liquid crystal dimming film is GH (Guest Host) liquid crystal. Said substrate 500 is made of transparent material and said substrate 500 is used for maintaining the mechanical integrity of the aftermarket dimmable sunroof and providing attachment points to be mounted to inner side of the original sunroof. Said liquid crystal dimming film 900 includes a first substrate layer 901, a first conductive layer 902, a liquid crystal layer 903, a second conductive layer 904, and a second substrate layer 905, which are stacked in a sequential order.

In this embodiment, it is preferred that the GH liquid crystal is the liquid crystal material used in the liquid crystal film, but it is also possible to select one of TN (Twisted Nematic) liquid crystal, VA (Vertical Alignment) liquid crystal, ECB (Electrically Controlled Birefringence) liquid crystal, and STN (Super Twisted Nematic) liquid crystal as the liquid crystal material used in the liquid crystal film according to the requirements. The Guest-Host (GH) type liquid crystal film utilizes dichroic dyes doped into a liquid crystal medium. When subjected to an external electric field, the guest (dye) molecules rotate in synchronization with the host (liquid crystal) molecules. Depending on the orientation of the dye molecules relative to the absorption axis of the molecular axis, dichroic dyes can be classified into two categories: positive (P-type) and negative (N-type). In the case of P-type dichroic dyes, when the electric field vector (E-vector) of the light is perpendicular to the dye's optical axis, the light largely passes through. Conversely, when the E-vector is parallel to the optical axis of the dye, the light is primarily absorbed. The N-type dichroic dyes function in the exact opposite way. By leveraging the distinct characteristics of P-type and N-type dyes, control over light absorption and transmission is achieved. This effectively changes the transmittance of the liquid crystal layer. Notably, GH-type liquid crystals eliminate the need for an additional polarizer due to their inherent properties. Dichroic dyes are utilized for their ability to selectively transmit light, which effectively fulfills the performance needs of the liquid crystal dimming layer. This enables precise control over the light and dark adjustments within the layer. Additionally, by altering the color of the dichroic dyes, the color of the liquid crystal dimming film in the dark state can be modified. This dual functionality ensures both luminance control and color variation within the liquid crystal layer. When electricity is supplied to the said liquid crystal dimming layer, the liquid crystal dimming layer is in a transparent state, with a transmittance range of 5% to 70%. When the power to the said liquid crystal dimming layer is cut off, the liquid crystal dimming layer is in a dark state, with a transmittance range of 0.1% to 15%.

The material employed within the liquid crystal dimming layer 300 can be chosen to be a Twisted Nematic (TN) liquid crystal material. Due to its optical rotation characteristics, when TN liquid crystal is designated as the material for the liquid crystal dimming layer 300, it is necessary to establish polarizing layers on the exterior sides of both said first substrate layer 901 and said second substrate layer 905. The transmission axes of these polarizers must be arranged in accordance with the optical rotation exhibited by the liquid crystal. In one instance, for example, the transmission axes of the two polarizers may be arranged perpendicularly to each other. When light passes through an outer polarizing layer, it becomes polarized and is subsequently twisted by its interaction with the TN liquid crystals present in the dimming layer 300. This twisted light can then traverse the inner polarizer, resulting in high light transmittance. Conversely, when an electric field is applied, the TN crystals reorient to an untwisted state, preventing the polarized light from passing through the inner polarizer, thereby causing lower light transmittance. Consequently, TN liquid crystals effectively modulate light and dark transitions, demonstrating proficient regulation of these changes.

In this embodiment, the aftermarket dimmable sunroof is set to a constant dark state, i.e., the aftermarket dimmable sunroof is in a dark state when the internal liquid crystal dimming layer 300 is in a power-off state, and the transmittance of the aftermarket dimmable sunroof can be adjusted by varying the voltage after energizing the aftermarket dimmable sunroof.

In this embodiment, said heat-insulating solar film 100 is a reflective heat-insulating solar film 100, capable of reflecting infrared and ultraviolet rays. The material of said substrate 500 preferably uses PC, and the thickness of said substrate 500 is set to 3 mm, and the material of said first adhesive layer 200 is OCA and said second adhesive layer 400 is TPU. The thickness of said first adhesive layer 200 is 0.050 mm and that of said second adhesive layer 400 is 0.76 mm.

In this embodiment, the drive module 700 of the aftermarket dimmable sunroof is directly installed in the vehicle's central control system, thereby realizing the control of the transmittance of the aftermarket dimmable sunroof through the vehicle system.

In the current embodiment, the vehicle's power supply 701 is selected as the power source for the aftermarket dimmable sunroof. Corresponding circuits are configured within the control chip 702 to adjust the output voltage and current size from the battery, in accordance with the user's requirements. To ensure safety, additional features such as overcharge and overdischarge protection are integrated into the system.

In this embodiment, a voice control module 704 and a wireless control module 705 are installed. The voice control module 704 can control the dimming function to turn on and off by voice commands; the wireless control module 705 can realize the control of dimming function by remote control methods such as via cell phone APP or a stand-alone remote control.

### Embodiment 3

This embodiment proposes an aftermarket dimmable sunroof comprising a heat-insulating solar film 100, a first adhesive layer 200, a liquid crystal dimming layer 300, a second adhesive layer 400, and a substrate 500 that are laminated in a sandwich type arrangement; Said liquid crystal dimming layer 300 contains two layers of liquid crystal dimming film, and said liquid crystal dimming film is used to adjust the transmittance of the aftermarket dimmable sunroof; the liquid crystal materials within the two said liquid crystal dimming films are GH liquid crystals, but the colors of the dye molecules within the two said liquid crystal dimming films are not the same, so that the colors presented by the two said liquid crystal dimming films are not the same. Said substrate 500 is made of transparent material, and said substrate 500 is used for maintaining the mechanical integrity of the aftermarket dimmable sunroof and providing attachment points to be mounted to inner side of the original sunroof. Two said liquid crystal dimming films have the same structure.

In this embodiment, the two layers of liquid crystal dimming films in the said liquid crystal dimming layer 300 are bonded together using OCA, and the two liquid crystal dimming films are connected to the drive module 700 by wires, and the drive module 700 has corresponding drive circuits in it. Because the colors of the two layers of liquid crystal dimming films are different, the color of the entire aftermarket dimmable sunroof can be controlled by adjusting the transmittance of the two liquid crystal dimming films.

In this embodiment, the aftermarket dimmable sunroof is set to a constant dark state, i.e., the aftermarket dimmable sunroof is in a dark state when the internal liquid crystal dimming layer 300 is in a power-off state, and the transmittance of the aftermarket dimmable sunroof can be adjusted by varying the voltage after energizing the aftermarket dimmable sunroof.

In this embodiment, said heat-insulating solar film 100 is a reflective heat-insulating solar film, capable of reflecting infrared and ultraviolet rays. The material of said substrate 500 is preferably made of PET, and the thickness of said substrate 500 is set to 2 mm, the material of said first adhesive layer 200 and said second adhesive layer 400 are the OCA and EVA respectively, and the thickness of said first adhesive layer 200 and said second adhesive layer 400 is 0.05 and 0.76 mm respectively.

In this embodiment, the drive module 700 of the aftermarket dimmable sunroof is directly installed in the vehicle's central control system, thereby realizing the control of the transmittance of the aftermarket dimmable sunroof through the vehicle system.

### Embodiment 4

This embodiment proposes an aftermarket dimmable sunroof including a liquid crystal dimming layer 300, a first adhesive layer 200, and a substrate 500 that are laminated in a sandwich type arrangement; said liquid crystal dimming layer 300 contains a layer of liquid crystal dimming film, said liquid crystal dimming film is used to adjust the transmittance of the aftermarket dimmable sunroof; the liquid crystal material within said liquid crystal dimming film is GH liquid crystal. Said substrate 500 is made of a transparent material and said substrate 500 is used for maintaining the mechanical integrity of the aftermarket dimmable sunroof and providing attachment points to be mounted to inner side of the original sunroof. Said liquid crystal dimming film 900 comprises a first substrate layer 901, a first conductive layer 902, a liquid crystal layer 903, a second conductive layer 904, and a second substrate layer 905, which are stacked in a sequential order.

In the present embodiment, the traditional substrate layer is enhanced through the incorporation of a heat-insulating material. Specifically, the first and second substrate layers 901 and 905 are made by introducing an infrared blocking (reflecting) agent and an ultraviolet absorber into the PET material. This innovation enables the liquid crystal dimming film of the present invention to possess an inherent heat-insulating function without the need of additional solar films.

In this embodiment, the entire aftermarket dimmable sunroof is relatively thin, the liquid crystal dimming layer 300 and the substrate 500 are flexible structures, and when being installed on the automobile sunroof 600, the substrate 500 only needs to be fixed around the periphery using the slot space between the automobile sunroof 600 and the vehicle headliner 1000. Driver module 700 and power supply 701 are directly installed to the vehicle center control. Power supply 701 uses the electric power from the vehicle.

### Embodiment 5

This embodiment proposes an aftermarket dimmable sunroof comprising a heat-insulating solar film 100, a first adhesive layer 200, a liquid crystal dimming layer 300, a second adhesive layer 400, and a substrate 500 that that are laminated in a sandwich type arrangement; said liquid crystal dimming layer 300 contains two layers of liquid crystal dimming film, and said liquid crystal dimming film is used to adjust the transmittance of the aftermarket dimmable sunroof; The liquid crystal materials within the two said liquid crystal dimming films are GH liquid crystals, but the colors of the dye molecules within the two said liquid crystal dimming films are different, so that the colors presented by the two said liquid crystal dimming films when dimming are different.

In this embodiment, by dividing the two said liquid crystal dimming films into grid-type dimming regions 800, for example, by dividing the two said liquid crystal dimming films into 100 dimming regions 800 of the same size, it is possible to divide the whole piece of the sunroof into a collection of individually controlled dimmable regions, and then by properly configuring the driver module 700, it is possible to display in different patterns or texts on a roof of a vehicle. It is also possible to divide the entire aftermarket dimmable sunroof into several large dimming zones 800, each corresponding to one of vehicle's seating area. This allows people sitting in each seat to make individual dimming control, without affecting others, thus improving the comfort of driver and passengers.

Specifically, the light transmittance of each dimming region can be controlled individually by the controller. When a dark state is desired, the transmittance of all zones can be simultaneously reduced; when a transparent state is desired, the transmittance of all zones can be simultaneously increased. This facilitates the adjustment of the color and transparency of the aftermarket dimmable sunroof to suit different needs.

It should be noted that to ensure safety and reliability, it is also necessary to add functions such as overcharge protection and overdischarge protection to the controller, and to provide appropriate protection measures for the circuit. At the same time, it is also necessary to add the voice control module 704 and the wireless control module 705 so that the user can realize the control of the color and transparency of the aftermarket dimmable sunroof by means of voice commands or cell phone APPs and the like.

It should be noted that the technical solutions between the various embodiments of the present invention can be combined with each other, but it must be based on what can be realized by a person of ordinary skill in the field, and when the combination of technical solutions appears to be contradictory or unattainable it should be assumed that the combination of such technical solutions does not exist, and is not within the scope of the protection claimed by the present invention.

The above mentioned is only a part or preferred embodiment of the present invention, neither the text nor the accompanying drawings can thus limit the scope of protection of the present invention, all the equivalent structural transformations made by utilizing the contents of the specification and the accompanying drawings of the present invention under the idea of an integral whole of the present invention, or directly/indirectly applying them in other related technical fields are included in the scope of protection of the present invention.

What is claimed is:

1. An aftermarket dimmable sunroof, designed to be installed onto the sunroof of a vehicle, characterized in that it includes, in order from top to bottom, a heat insulating solar film, a first adhesive layer, a liquid crystal dimming layer, a second adhesive layer, and a substrate, which are laminated in a sandwich type arrangement;
said aftermarket dimmable sunroof is fixedly installed on the inner side of the original sunroof glass of the vehicle by an adhesive or mechanical fixation structure;
said liquid crystal dimming layer comprises at least one layer of liquid crystal dimming film used for regulating the transmittance of the aftermarket dimmable sunroof;
said liquid crystal material within the liquid crystal dimming film comprises liquid crystal molecules, chiral dopants, and dye molecules;
said substrate is made of transparent material, and said substrate is used for maintaining the mechanical integrity of the aftermarket dimmable sunroof and providing attachment points to be attached to inner side of the original sunroof;
when electricity is supplied to the liquid crystal dimming layer, it is transparent with a transmittance range of 5%-70%; when the power supply to the liquid crystal dimming layer is cut off, it is in a dark state, with a transmittance range of 0.1%-15%.

2. The aftermarket dimmable sunroof according to claim 1, characterized in that the heat insulating solar film is a reflective heat insulating solar film capable of reflecting infrared and ultraviolet radiation.

3. The aftermarket dimmable sunroof according to claim 1, characterized in that the liquid crystal material within the liquid crystal dimming layer is a PDLC material, capable of switching between transparency and opaqueness, when electricity is supplied to the liquid crystal dimming layer, it is in a transparent state with a transmittance range of 5%-80%; when the power supply to the liquid crystal dimming layer is cut off, it is in a dark state, with a transmittance range of 0.5%-20%.

4. The aftermarket dimmable sunroof according to claim 1, characterized in that the material of said substrate (500) is one of PC, PET, PMMA, PVC, PP, TAC.

5. The aftermarket dimmable sunroof according to claim 1, characterized in that said first adhesive layer (200) and said second adhesive layer (400) are made of one of OCA, PVB, EVA, TPU.

6. The aftermarket dimmable sunroof according to claim 1, characterized in that the thickness of said first adhesive layer (200) and said second adhesive layer (400) ranges from 0.05 mm to 2 mm, and the thickness of said substrate (500) ranges from 2 mm to 5 mm.

7. The aftermarket dimmable sunroof according to claim 1, characterized in that said liquid crystal dimming film comprises a first substrate layer (901), a first conductive layer (902), a liquid crystal layer (903), a second conductive layer (904), and a second substrate layer (905) stacked in a sequential order;
said aftermarket dimmable sunroof further comprises a drive module, said drive module (700) being electrically connected to said first conductive layer (902) and said second conductive layer (904), respectively, for applying a drive voltage to said first conductive layer and said second conductive layer.

8. The aftermarket dimmable sunroof according to claim 7, characterized in that said drive module comprises a power supply, a control chip and a switch, and said control chip is electrically connected to said first conductive layer, said second conductive layer, said power supply and said switch, respectively.

9. The aftermarket dimmable sunroof according to claim 8, characterized in that said power source comprises a transparent solar film, said transparent solar film being attached to the side of said insulating solar film facing outward relative to the cockpit of the vehicle; or
said power source comprises a rechargeable battery; or
said power source comprises an automotive battery.

10. The aftermarket dimmable sunroof according to claim 7, characterized in that said drive module further comprises a voice control module and a wireless control module.

11. An aftermarket dimmable sunroof, characterized in that it includes, from top to bottom, a reflective heat-insulating solar film, a first adhesive layer, a liquid crystal dimming layer, a second adhesive layer, and a polycarbonate (PC) substrate with a thickness of 2 mm, which are laminated in a sandwich type arrangement; said aftermarket dimmable sunroof is fixedly installed on the inner side of the original sunroof glass of the vehicle by an adhesive or mechanical fixation structure; said liquid crystal dimming layer comprises at least one layer of liquid crystal dimming film containing GH guest-host dye liquid crystal material for regulating the transmittance of the aftermarket dimmable sunroof; when electricity is supplied to the liquid crystal dimming layer, it is transparent with a transmittance range of 5%-70%; when the power supply to the liquid crystal dimming layer is cut off, it is in a dark state, with a transmittance range of 0.1%-15%.

12. The aftermarket dimmable sunroof according to claim 11, characterized in that the liquid crystal dimming film includes a first substrate layer, a first conductive layer, a liquid crystal layer, a second conductive layer, and a second substrate layer stacked in a sequential order; said liquid crystal material within the liquid crystal layer is a GH guest-host dye liquid crystal that dissolves dichroic dyes to form a host-guest relationship, achieving light absorption or transmission through an external electric field to change the transmittance of the liquid crystal dimming layer.

13. The aftermarket dimmable sunroof according to claim 11 or 12, characterized in that it further includes a drive module directly mounted on the vehicle's center console, connected to the vehicle's infotainment system for controlling the transmittance of the aftermarket dimmable sunroof through the infotainment system; said drive module is connected to the vehicle's infotainment power source and regulates the output voltage and current of the battery through a control chip, featuring overcharge and deep discharge protection functions.

14. The aftermarket dimmable sunroof according to claim 11, characterized in that it further includes a voice control module and a wireless control module; said voice control module controls the on/off function of the dimming feature through voice commands; said wireless control module achieves remote control of the dimming function via mobile apps, Bluetooth, etc.; additionally, a remote control can be set up to manage the dimming function.

15. The aftermarket dimmable sunroof according to claim 11, characterized in that the first adhesive layer and the second adhesive layer are made of polyvinyl butyral (PVB) material, each with a thickness of 2 mm.
